(19) United States
(12) Patent Application Publication
(10) Pub. No.: US 2015/0227900 A1
(43) Pub. Date: Aug. 13, 2015

(54) BUSINESS TO BUSINESS INVOICE GENERATION AND PAYMENT SYSTEM AND METHOD USING MOBILE PHONES

(71) Applicant: GCS INTERNATIONAL, LTD., Santo Domingo (DO)

(72) Inventor: Day Jimenez, Miami, FL (US)

(73) Assignee: GCS INTERNATIONAL, LTD., Santo Domingo (DO)

(21) Appl. No.: 14/423,052

(22) PCT Filed: Aug. 22, 2013
(86) PCT No.: PCT/US13/56257

§ 371 Date: Feb. 20, 2015

Related U.S. Application Data
(60) Provisional application No. 61/692,474, filed on Aug. 23, 2012.

(51) Int. Cl. G06Q 20/10; G06Q 20/26; G06Q 20/32; G06Q 30/04

(52) U.S. Cl. CPC G06Q 20/102; G06Q 30/04; G06Q 20/26; G06Q 20/322

(57) ABSTRACT

A method and system for processing invoice transactions between vendors (distributors) and retailers (merchants) via mobile phone is disclosed. Each distributor has a unique vendor identifier. Each retailer has a unique identifier, typically his/her mobile phone number. An intermediary system processes payments and upon verification of account balance at retailer's bank, the intermediary system notifies the vendor bank, debits the funding account at the retailer's bank, processes a credit to the vendor's bank, and sends an approval message to the retailer's mobile phone.

### BACKGROUND

1. Field

The present disclosure generally relates to financial transaction systems and methods and more particularly to a computerized system and method for processing bank/business financial transactions utilizing mobile phones.

2. Description of Related Art

Several mobile payment initiatives have been implemented in different parts of the world using various mobile payment technologies and methods which mostly require sophisticated handsets (e.g. smart phones), mobile communication components (e.g. near field communication (NFC)) and subscriber identity module (SIM)/chip technologies, with the ability to use wireless application protocol (WAP)/Internet facilities to perform financial transactions and other mobile services in a mobile commerce economy. However, the globalization of these mobile payment solutions is still limited by certain market conditions, cost of compatible mobile devices and services, availability of funding sources, and network/acquirer infrastructure. The convergence of mobile and payment has proven to be a complex undertaking, requiring the association and cooperation of multiple business players and partners. What is needed is a simple, straightforward system and method for utilizing existing mobile phone technology and existing payment processing system capabilities cooperating to facilitate transactions through an intermediary bank between product suppliers/distributors and their retail vendors.

### SUMMARY

The present disclosure utilizes a USSD (Unstructured Supplementary Service Data) capability that exists in current mobile phones and current smartphones and tablet PC API's to facilitate transaction inquiry and transaction reporting between vendors (distributors or suppliers) and their bank to and from merchants (retailers) such that paper money transactions are virtually eliminated thus simplifying the distribution and delivery of goods and transfer of payments for such goods in a more seamless manner.

The present disclosure provides a simple and secure process solution that integrates standard, readily available mobile technologies (e.g., GSM USSD) with business stakeholders (e.g., merchants, banks, etc.) to enable business customer payments in a seamless and effective manner through the use of a unique mobile payment system and software application.

An embodiment of the present disclosure is a method of generating and processing a payment to a vendor for an invoice from the vendor to a retailer via a mobile phone. This method includes operations of providing a mobile phone to a retailer having stored therein a payer identifier unique to the retailer, entering a transaction amount into the mobile phone and identifying the vendor on the mobile phone, generating a transaction authorization request message in the retailer's mobile phone, and sending the transaction authorization request via an intermediary to debit the retailer's funding account. An intermediary instructs the retailer's bank to debit the funding account, confirms a corresponding credit to the vendor's account, and sends a confirmation message via the intermediary to the retailer's mobile phone and to the vendor.

An exemplary embodiment of a method in accordance with disclosure of generating and processing a payment to a vendor for an invoice from the vendor to a retailer via a mobile phone includes operations of providing a mobile phone to a retailer having stored therein a payer identifier unique to the retailer, entering a transaction amount into the mobile phone and identifying the vendor on the mobile phone, generating a transaction authorization request message in the retailer's mobile phone, and sending the transaction authorization request via an intermediary to debit the retailer's funding account. The intermediary instructs the retailer's bank to debit the funding account. The intermediary confirms a corresponding credit to the vendor's account, and sends a confirmation message to the retailer's mobile phone and to the vendor.

The operation of identifying the vendor on the mobile phone includes inputting a unique payee identifier for the vendor into the retailer's mobile phone. The intermediary is preferably separate and distinct from the retailer, the retailer's bank, the vendor's account and the vendor.

The intermediary in one embodiment generates a request to the retailer's mobile phone to display bill payment, balance inquiry and transaction history options on the retailer's mobile phone. The intermediary, in response to an option selection by the retailer, queries the retailer's phone for a personal identification number (PIN); and upon PIN confirmation, facilitates communication between the retailer's bank and the vendor's account. In an embodiment, the intermediary includes operations of receiving from a vendor an electronic invoice and notifying the retailer of the invoice, receiving via the mobile phone payment authorization from the retailer, receiving response instruction from the funding account, and sending confirmation of payment to both the vendor and the retailer.

An exemplary embodiment of a payment system in accordance with this disclosure is a system for processing a payment to a vendor for an invoice from the vendor to a retailer via a retailer's mobile phone. Such a system preferably includes a computing device having a processor operably connected to a common database and communicatively coupled to a bank, a retailer's mobile phone, retailer's account and a vendor's account. The computing device is programmed to receive from the retailer's mobile phone having stored therein a payer identifier unique to the retailer, a transaction amount, identity of a vendor, and a transaction authorization request message. The computing device sends the transaction authorization request to a bank to debit the retailer's funding account, instructs the retailer's bank to debit the funding account, confirms a corresponding credit to the vendor's account, and sends a confirmation message to the retailer's mobile phone and to the vendor.

Another embodiment of the present disclosure may include a tangible non-transitory machine readable medium storing instructions that, when executed by a computing device, cause the computing device to perform a method of generating and processing a payment to a vendor for an invoice from the vendor to a retailer via a mobile phone. In such an embodiment, the method may include operations of receiving, in an intermediary, from a retailer's mobile phone having stored therein a payer identifier unique to the retailer, a transaction amount and identity of a vendor and a transaction authorization request message, sending the transaction authorization request to a bank via the intermediary to debit the retailer's funding account, instructing the retailer's bank to debit the funding account, confirming a corresponding credit to the vendor's account, and sending a confirmation message via the intermediary to the retailer's mobile phone and to the vendor.

These and other aspects and advantages, and novel features of this new technology are set forth in part in the description that follows and will become apparent to those skilled in the art upon examination of the following description and figures, or may be learned by practicing one or more embodiments of the technology provided for by the present disclosure.

### BRIEF DESCRIPTION OF THE DRAWINGS

FIG. 1 illustrates the business to business invoice generation and payment processing concept in accordance with the present disclosure.

FIG. 2 illustrates the step by step process of the invoice collection process between a retailer and a vendor (distributor) in accordance with the present disclosure.

FIG. 3 is a display of interface screens presented to a vendor for creating an invoice in the system in accordance with the present disclosure.

FIG. 4 is a display of vendor interface screens presented to a vendor for invoice review in accordance with the present disclosure.

FIG. 5 is a sequence of screen shots presented on a retailer's mobile phone as part of the USSD session to execute a payment transaction or review the retailer's account balance in accordance with the present disclosure.

FIG. 6 is a sequence of USSD screens displayed on a retailer's mobile phone for a transaction inquiry in accordance with the present disclosure.

FIG. 7 is a transactional flow diagram between a bank, a distributor and a retailer utilizing an intermediary in accordance with the present disclosure.

### DETAILED DESCRIPTION

In the following detailed description of various embodiments of the disclosure, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The end-to-end process in accordance with the present disclosure preferably takes advantage of key mobile and network technologies namely the USSD protocol and network-generated USSD Push feature to provide a special customer experience for exchanging information to facilitate real-time/online payments and transactions.

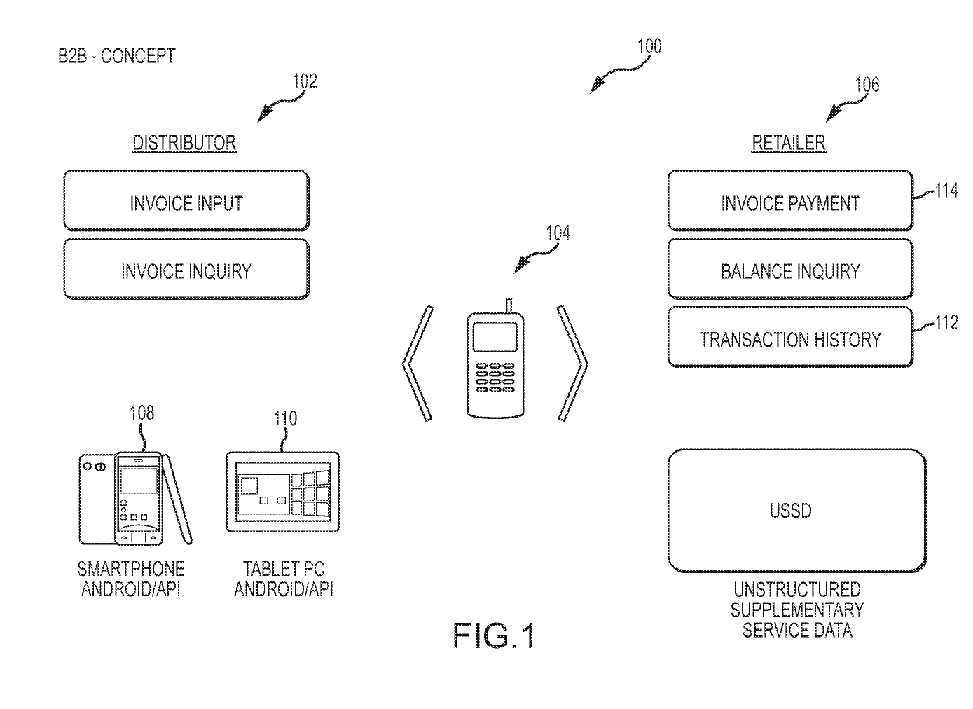

Turning now to the drawings, a concept diagram of the basic business to business process 100 between a distributor or vendor 102 via mobile phone 104 to and from a retail merchant 106 is shown in FIG. 1. Preferably the distributor 102 generates invoices and reviews existing invoices via a mobile phone 104 or, more preferably, via an application programming interface (API) resident on the distributor's smartphone 108 or tablet PC 110.

Similarly, the retailer merchant 106 can view on his or her mobile phone 104 payments made to suppliers, 112, view pending invoices and/or make payments 114 to distributors 102. Both the distributor and the retailer may utilize existing USSD capabilities on their mobile phones 104 in order to perform these functions. Alternatively, as is shown in FIG. 1, the distributor 102 may utilize an API resident on a smartphone 108 or tablet PC 110 to perform these functions.

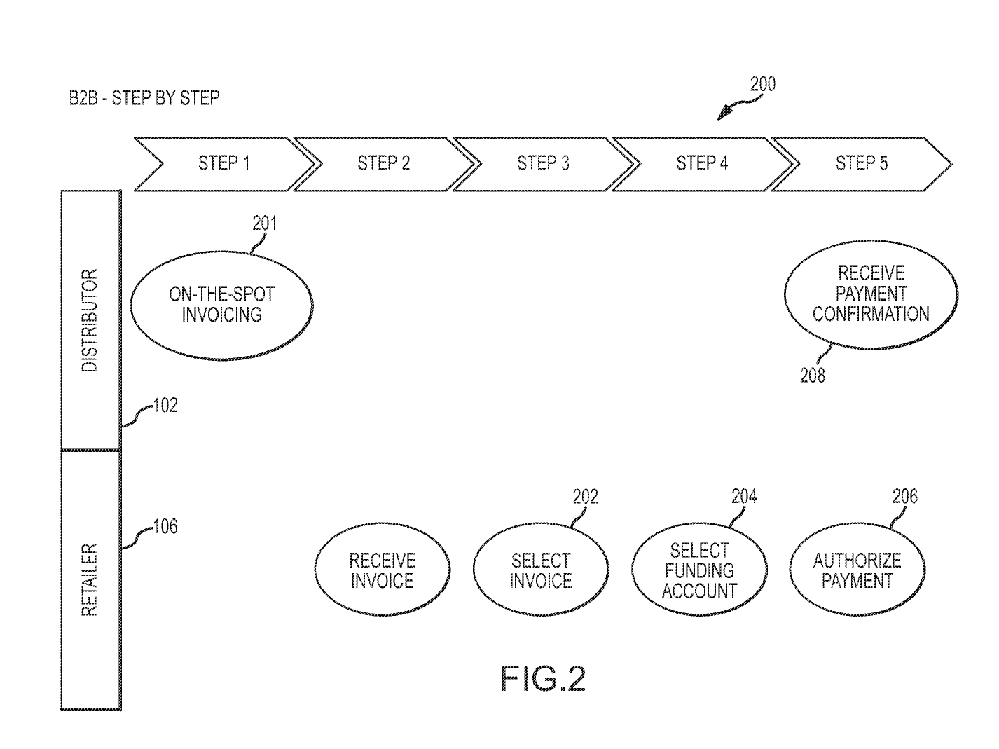

An illustration of the operational process steps 200 involved in a retailer 106 making a payment to a distributor 102 is shown in FIG. 2. First, the distributor 102 issues an “on-the-spot” invoice 201 via the API on the distributor's computer, smartphone 108 or tablet PC 110 at step 1. On the retailer side, the retailer 106 at step 2 receives the invoice, for example, via USSD session on his or her mobile phone 104. At step 3, the retailer 106 selects the invoice payment type in operation 202. At step 4, the retailer 106 selects the funding account in operation 204, i.e., whether the payment is to be a debit from his/her cash account or from a different source. At step 5, the payment is authorized in operation 206 and a confirmation is sent to the distributor 102 in operation 208.

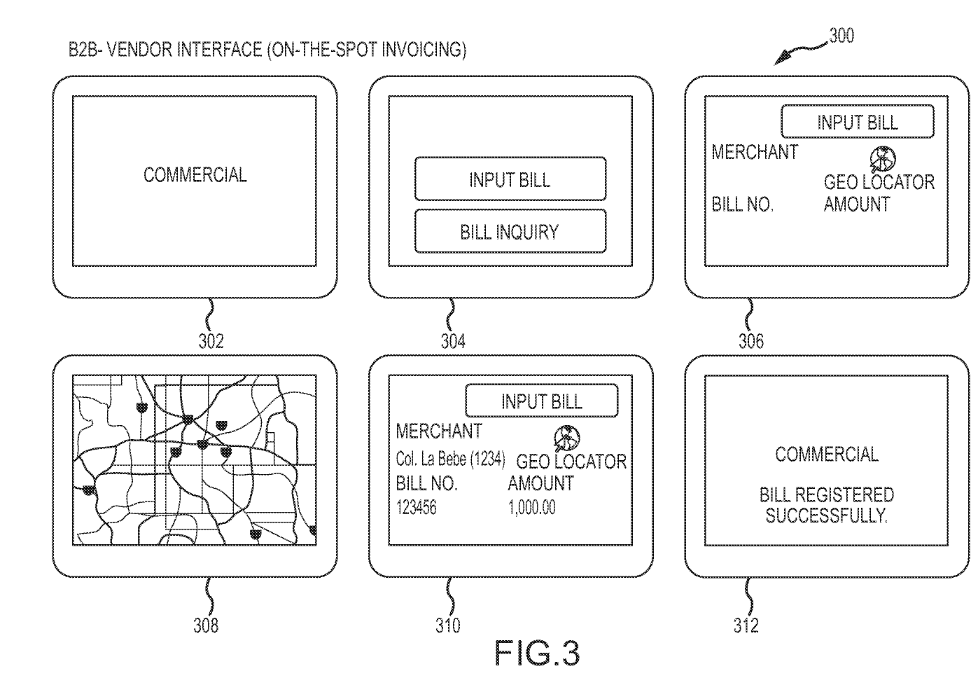

FIG. 3 shows a sequence of exemplary vendor interface screens 300 displayed to the distributor 102 for creation of an “on-the-spot” invoice. First an introductory screen 302 is displayed to indicate that the intermediary process has begun. Control then transfers to screen 304 which presents a choice to the distributor 102 whether to input a new invoice to a merchant (retailer) 106 or simply display existing invoices. When the distributor 102 selects “Input Bill”, control transfers to screen 306 which permits the distributor 102 to input the merchant (retailer) name, distributor's bill number, and invoice amount. Next, screen 308 displays the location of the merchant (retailer) 106 on a geo-location map. Control then transfers to screen 310 which displays the merchant, the distributor's invoice number and amount of the invoice. When the distributor 102 clicks on or otherwise confirms that the invoice shown in screen 310 is correct, control transfers to screen 312 which indicates that the bill is registered in the system 100 successfully. This completes the generation of a bill to the retailer 106.

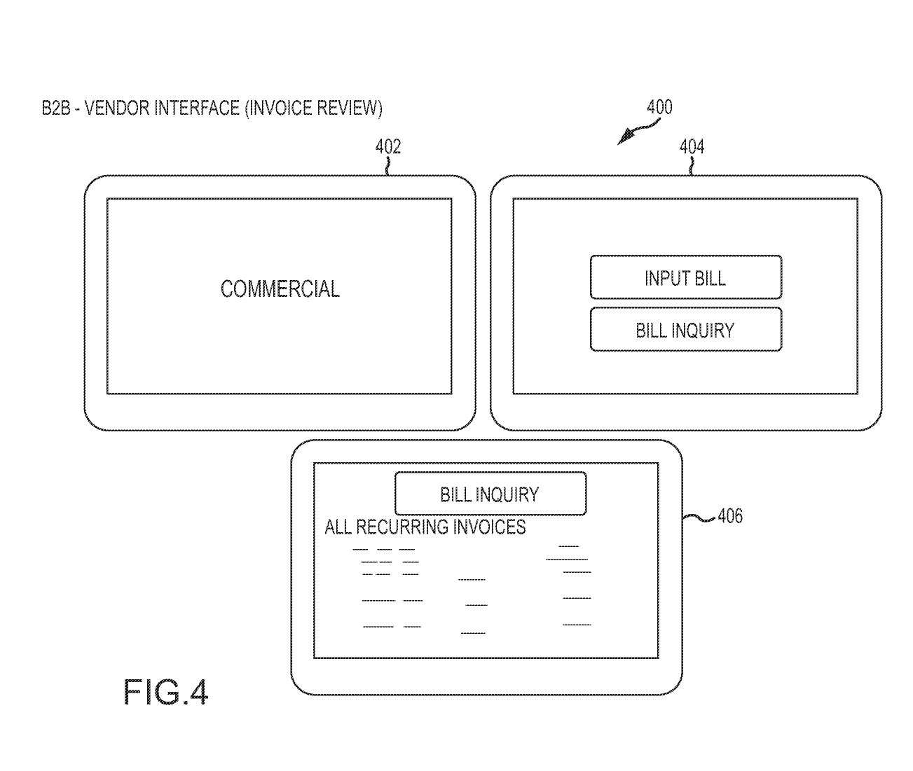

A series of vendor interface screens 400 is shown in FIG. 4. Again, on screen is displayed the vendor interface top screen 402. Control then transfers to operation 404 where the distributor 102 is presented with a choice to input a new bill or inquire about existing bills (invoices). If the distributor selects “Bill Inquiry”, control transfers to operation 406 where the existing invoices are displayed for the distributor's information.

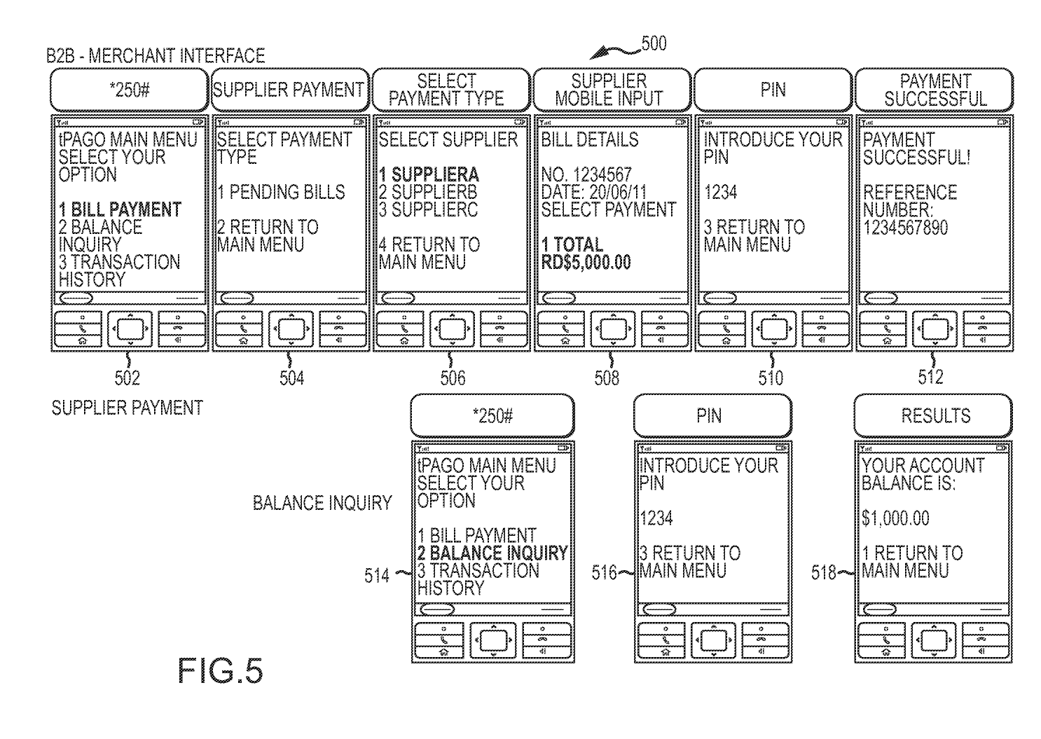

A series of retailer (merchant) interface screens 500 is shown in FIG. 5. These screens are displayed via USSD session on the retailer's mobile phone 104. Upon entering a proper sign-in code *250#, a main menu 502 is shown. This main menu gives the retailer 106 options for display. The interface 500 displays a selection of payment types in screenshot 504 when the retailer selects Bill Payment. If the Pending Bills selection is made, a further selection is shown to permit the retailer 106 to select which supplier (vendor/distributor) is to be paid in screen shot 506. Choosing Supplier A then causes the system to display a screen 508 that shows the Bill Details for Supplier A, and permits the retailer 106 to input the amount to be paid on that invoice. Upon input of an amount, in this example, $5,000.00, control transfers to display a screen 510 asking for input of the retailer's personal identification number (PIN). Upon successful entry of the proper PIN, the payment is applied from the funding account to the distributors account, and, if the transaction is successful, a screen 512 is displayed to the retailer to indicate that the payment was successful and provide the retailer with a transaction reference number for that transaction.

Alternatively, when the main menu 502 is displayed, if the retailer selects option 2, “Balance Inquiry”, as shown on screen 514, again the retailer's PIN is requested on screen 516. Upon proper PIN entry, a balance screen 518 is displayed, providing the retailer 106 with a display of the current balance in his funding account.

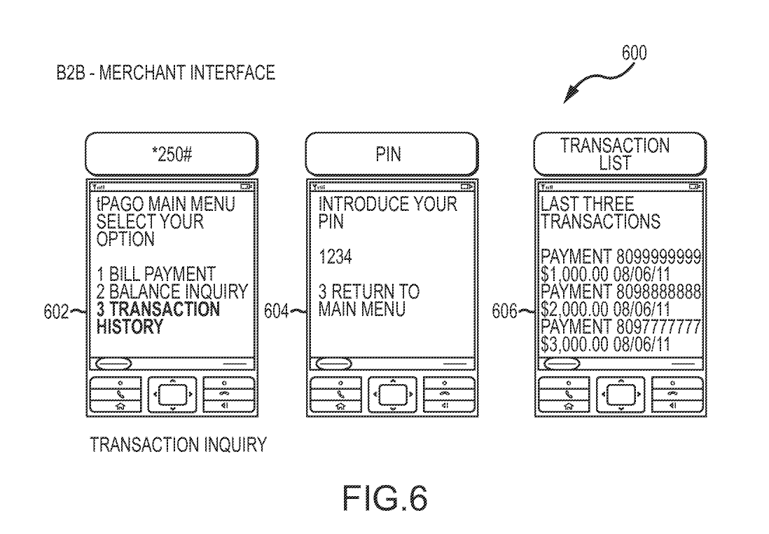

If the retailer 106 selects option 3 “Transaction History” as is shown in FIG. 6, a sequence of screens 600 is shown to the retailer 106. Upon entry of the exemplary code *250# to call the merchant interface in accordance with the present disclosure, the main menu 602 is displayed. When option 3 is selected, again a screen 604 is displayed requesting the retailer's PIN. Upon proper entry of the retailer's PIN, a list of the transactions previously made is displayed in screen 606.

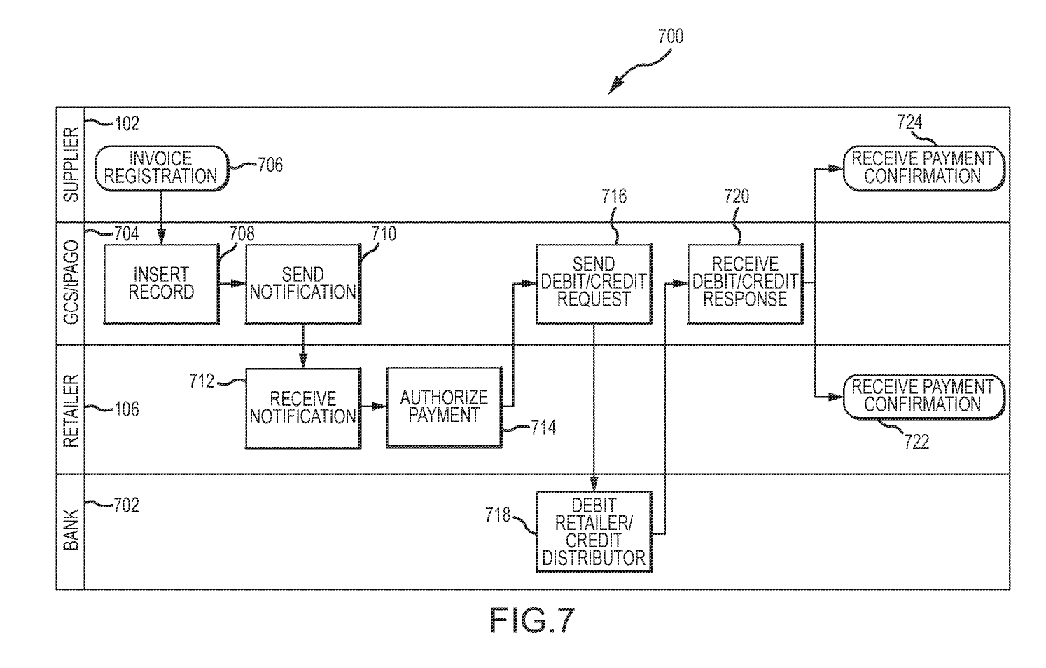

An exemplary process flow diagram of the operations 700 involved in an exemplary business to business invoice payment to suppliers system is shown in FIG. 7. This process 700 involves the vendor/supplier 102, the retailer/merchant 106, the funding bank 702 and an intermediary 704. Most of the processing activity takes place in the intermediary 704 rather than in either the vendor's bank or the retailer's bank. The use of the intermediary 704 thus frees resources of the vendor and retailer's banks

The process 700 begins in operation 706. Here the supplier (distributor) 102 generates an invoice and registers the invoice (bill) as shown in FIGS. 2 and 3. Control then transfers to operation 708 where a record of the invoice is stored in the intermediary system 704. Control then transfers to operation 710 within the intermediary system 704. In operation 710, the intermediary system 704 sends a notification to the retailer 106 that an invoice has been generated by the distributor 102. Control transfers to operation 712. In operation 712, the retailer 106 receives and acknowledges notification of the invoice. When the retailer 106 takes steps to authorize payment as shown above in FIG. 5, control transfers to operation 714 where the steps shown in FIG. 5 are performed. Control then transfers to operation 716.

In operation 716, the intermediary 704 receives the payment authorization and generates both a debit and a credit request for the bank(s) 702. Control then transfers to operation 718. In operation 718, the bank(s) debit the retailer funding account and credit the distributor account in accordance with the debit/credit request generated in operation 716. Control then transfers back to the intermediary 704 in operation 720.

In operation 720, the debit/credit response is received from the bank(s) and the intermediary 704 generates a message 722 to the retailer 106 confirming payment has been made, and at the same time generating a message 724 to the distributor 102 that the payment receipt has been confirmed.

It is clear that many modifications and variations of this embodiment may be made by one skilled in the art without departing from the spirit of the novel art of this disclosure. In particular, in addition to electronic communication means such as email, SMS, IM, etc., messages may also be exchanged by means of a voice XML (Extensible Markup Language) or IVR (Interactive Voice Response) system or other, similar automated voice telephone system. In other cases, other suitable, similar messaging media or web interfaces may be offered for interaction with the system to achieve an exchange of information. These variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A method of generating and processing a payment to a vendor for an invoice from the vendor to a retailer via a mobile phone, the method comprising:
providing a mobile phone to a retailer having stored therein a payer identifier unique to the retailer;
entering a transaction amount into the mobile phone and identifying the vendor on the mobile phone;
generating a transaction authorization request message in the retailer's mobile phone;
sending the transaction authorization request via an intermediary to debit the retailer's funding account;
the intermediary instructing the retailer's bank to debit the funding account;
the intermediary confirming a corresponding credit to the vendor's account; and
sending a confirmation message via the intermediary to the retailer's mobile phone and to the vendor.

2. The method according to claim 1 wherein identifying the vendor on the mobile phone includes inputting a unique payee identifier for the vendor into the retailer's mobile phone.

3. The method according to claim 2 wherein the intermediary is separate and distinct from the retailer, the retailer's bank, the vendor's account and the vendor.

4. The method according to claim 1 wherein the intermediary generates a request to the retailer's mobile phone to display bill payment, balance inquiry and transaction history options on the retailer's mobile phone.

5. The method according to claim 4 wherein the intermediary, in response to an option selection by the retailer, queries the retailer's phone for a personal identification number (PIN); and upon PIN confirmation, facilitates communication between the retailer's bank and the vendor's account.

6. The method according to claim 1 further comprising:
the intermediary receiving from a vendor an electronic invoice and notifying the retailer of the invoice;
the intermediary receiving via the mobile phone payment authorization from the retailer;
the intermediary receiving response instruction from the funding account; and
sending confirmation of payment to both the vendor and the retailer.

7. A system for generating and processing a payment to a vendor for an invoice from the vendor to a retailer via a mobile phone, the system comprising:
a retailer having a mobile phone having stored therein a payer identifier unique to the retailer;
means for entering a transaction amount into the mobile phone and identifying the vendor on the mobile phone;
means for generating a transaction authorization request message in the retailer's mobile phone;
means for sending the transaction authorization request via an intermediary to debit the retailer's funding account;
means for instructing the retailer's bank to debit the funding account;
means for confirming a corresponding credit to the vendor's account; and
means for sending a confirmation message via the intermediary to the retailer's mobile phone and to the vendor.

8. The system according to claim 7 wherein means for identifying the vendor on the mobile phone includes providing a unique payee identifier for the vendor to the retailer's mobile phone.

9. The system according to claim 8 wherein the intermediary is separate and distinct from the retailer, the retailer's bank, the vendor's account and the vendor.

10. The system according to claim 7 wherein the intermediary included means for generating a request to the retailer's mobile phone to display bill payment, balance inquiry and transaction history options on the retailer's mobile phone.

11. The system according to claim 10 wherein the intermediary, in response to an option selection by the retailer, queries the retailer's phone for a personal identification number (PIN); and upon PIN confirmation, facilitates communication between the retailer's bank and the vendor's account.

12. The system according to claim 7 further comprising the intermediary being operable to:
provide an electronic invoice from a vendor and notify the retailer of the invoice;
receive via the mobile phone payment authorization from the retailer;
receive a response instruction from the funding account; and
send confirmation of payment to both the vendor and the retailer.

13. A tangible non-transitory machine readable medium storing instructions that, when executed by a computing device, cause the computing device to perform a method of generating and processing a payment to a vendor for an invoice from the vendor to a retailer via a mobile phone, the method comprising:
receiving, in an intermediary, from a retailer's mobile phone having stored therein a payer identifier unique to the retailer, a transaction amount and identity of a vendor and a transaction authorization request message;
sending the transaction authorization request to a bank via the intermediary to debit the retailer's funding account;
instructing the retailer's bank to debit the funding account;
confirming a corresponding credit to the vendor's account; and
sending a confirmation message via the intermediary to the retailer's mobile phone and to the vendor.

14. A system for processing a payment to a vendor for an invoice from the vendor to a retailer via a retailer's mobile phone, the system comprising:
a computing device having a processor operably connected to a common database and communicatively coupled to a bank, a retailer's mobile phone, retailer's account and a vendor's account, wherein the computing device is programmed to:
receive from the retailer's mobile phone having stored therein a payer identifier unique to the retailer, a transaction amount, identity of a vendor, and a transaction authorization request message;
send the transaction authorization request to a bank to debit the retailer's funding account;
instruct the retailer's bank to debit the funding account;
confirm a corresponding credit to the vendor's account; and
send a confirmation message to the retailer's mobile phone and to the vendor.
